(19) United States
(12) Patent Application Publication
(10) Pub. No.: US 2012/0203590 A1
(43) Pub. Date: Aug. 9, 2012

(54) Technology Risk Assessment, Forecasting, and Prioritization

(75) Inventors: Subhajit Deb, Gurgaon (IN); William Tyler Thornhill, Forney, TX (US); Matthew L. Weber, Charlotte, NC (US); Chandrashekar Katuri, Charlotte, NC (US); Krishna Reddy Mandala, Hyderabad (IN)

(73) Assignee: Bank of America Corporation, Charlotte, NC (US)

(21) Appl. No.: 13/020,884

(22) Filed: Feb. 4, 2011

(51) Int. Cl. G06Q 10/00

(52) U.S. Cl. 705/7.28

(57) ABSTRACT

A computer system assesses the overall risk for different technologies for an organization. Technologies may be evaluated by obtaining severity levels and environmental risk scores for the vulnerabilities associated with the technologies. Each severity level measures a possible risk level of a corresponding vulnerability, while each environmental risk score is based on the organization's environment. Technology risk scores are then determined from the severity levels and the environmental risk scores. Each technology may then be categorized from a statistical distribution of the technology risk scores. An indexed risk score for each technology may also be determined based on time trending variables. Inputs may be a number of vulnerabilities, blended advisory/severity scores, and a standard deviation of the blended advisory/severity scores, and the results then provide behavior forecasting of the technologies. Further evaluation of the technologies may be performed to determine a risk versus reward model for the different technologies.

### FIELD

Aspects of the embodiments relate to a computer system that assesses the risk of a technology that is utilized by an organization, where different technologies may incorporate different software packages.

### BACKGROUND

Business, government, technical, and education organizations typically utilize systems and that incorporate one or more technologies. For example, an information technology (IT) system may utilize one or more software modules for processing information within an organization, where each software module corresponds to a technology. The value of the system to the organization is typically based on the proper operation of the incorporated technologies within the system.

Traditional approaches typically assess a technology by analyzing different vulnerabilities associated with the technology, where each vulnerability is defined as a set of conditions that may lead to an implicit or explicit failure of the system. For example, the assessment of an IT system may use an open framework provided by the Common Vulnerability Scoring System (CVSS) for communicating the innate characteristics and impacts of each individual vulnerability. Common causes of vulnerabilities are design flaws in software and hardware, botched administrative processes, lack of awareness and education in information security, technological advancements, and improvements to current practices, any of which may result in real threats to mission-critical information systems. The quantitative CVSS model ensures repeatable accurate measurement while enabling users to see the underlying vulnerability characteristics that were used to generate the scores. The CVSS model is consequently well suited as a standard measurement approach for industries, organizations, and governments that need accurate and consistent vulnerability impact scores for each vulnerability.

### BRIEF SUMMARY

Aspects of the embodiments address one or more of the issues mentioned above by disclosing methods, computer readable media, and apparatuses that assess the overall risk different technologies that may incorporate different software packages for an organization. An organization may assume one of different entities, including a financial institution, a manufacturing company, an educational institution, or a governmental agency. A technology is typically associated with numerous vulnerabilities, and consequently the risk assessment of one vulnerability may not adequately reflect the overall risk level of the technology.

According to an aspect of the invention, a mathematical and objective approach assesses the relative risk of different technologies in order to provide a macro view of product-related risk across an organization's entire technology portfolio, where the products may comprise one or more software packages. The approach determines the threat risk for various software groups based on prior security findings over a known time span. The results may be used to determine which software packages are not a concern, within tolerance, and need to be addressed for possible alternatives within the organization. Measurements allow for the analysis of vendor process maturity and adjustment of behavior to create a lower risk rating as opposed to eliminating a software package for use in the organization.

According to another aspect of the invention, technologies are evaluated by obtaining severity levels and environmental risk scores for the vulnerabilities associated with the technologies. Each severity level measures a possible risk level of a corresponding vulnerability for an organization, while each environmental risk score is based on an environment of the organization. Technology risk scores are then determined from the severity levels and the environmental risk scores over a time duration. Each technology may then be categorized from a statistical distribution of the technology risk scores.

According to another aspect of the invention, an indexed risk score for each technology is determined based on time trending variables. Inputs may be a number of vulnerabilities (which may be referred to as issues), blended advisory/severity scores, the standard deviation of the blended advisory/severity scores, and the results then provide behavior forecasting of the technologies over a subsequent time duration. Further evaluation of the technologies may be performed in order to determine a risk versus reward model for the different technologies. Embodiments may model the reward of a technology based on the cost and complexity of patching as well as the degree of vendor support for the technology, while the risk may be based on a risk score of the technology.

Aspects of the embodiments may be provided in a computer-readable medium having computer-executable instructions to perform one or more of the process steps described herein.

These and other aspects of the embodiments are discussed in greater detail throughout this disclosure, including the accompanying drawings.

### BRIEF DESCRIPTION OF THE DRAWINGS

The present invention is illustrated by way of example and not limited in the accompanying figures in which like reference numerals indicate similar elements and in which:

FIG. 1 shows an illustrative operating environment in which various aspects of the invention may be implemented.

FIG. 2 is an illustrative block diagram of workstations and servers that may be used to implement the processes and functions of certain aspects of the present invention.

FIG. 3 shows a process of assessing technologies in accordance with an aspect of the invention.

FIG. 4 shows an example of technology risk assessment by risk score in accordance with an aspect of the invention.

FIG. 5 shows a process for evaluating a technology when the associated risk score exceeds a predetermined limit in accordance with an aspect of the invention.

FIG. 6 shows an example of technology risk assessment by lemon value in accordance with an aspect of the invention.

FIG. 7 shows an example of technology risk assessment by current indexed risk in accordance with an aspect of the invention.

FIG. 8 shows an example of technology risk assessment by forecasted indexed risk in accordance with an aspect of the invention.

FIG. 9 shows an example of indexed risk over time in accordance with an aspect of the invention.

FIG. 10 shows an example of indexed risk over time in accordance with an aspect of the invention.

FIG. 11 shows an example of cost remediation for technologies in accordance with an aspect of the invention.

FIG. 12 shows an example of risks and rewards for different technologies in accordance with an aspect of the invention.

FIG. 13 shows a graphical representation of the example shown in FIG. 12.

### DETAILED DESCRIPTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope and spirit of the present invention.

In the description herein, the following terms are referenced.

Software Package: A software package may refer to any component (or module) that can be integrated into a main program. Typically this is done by the end user in a well-defined interface. In other contexts, the integration may occur at a source code level of a given programming language.

Technology: A technology may be broadly defined as an entity that achieves some value. Consequently, a technology may refer to a tool, machine, computer software (e.g., a software package including Adobe® Reader® and Microsoft Internet Explorer®), or a technique that may be used to solve problems, fulfill needs, or satisfy wants. Moreover, a technology may include a method to do business or a manufacturing process.

Vulnerability: A vulnerability may be defined as a set of conditions that may lead to an implicit or explicit failure of the confidentiality, integrity, or availability of a system (e.g., an information system) or process. For example with a software package, vulnerabilities may be associated with memory corruption, buffer overflow, and security weaknesses. Examples of unauthorized or unexpected effects of a vulnerability in an information system may include executing commands as another user, accessing data in excess of specified or expected permission, posing as another user or service within a system, causing an abnormal denial of service, inadvertently or intentionally destroying data without permission, and exploiting an encryption implementation weakness that significantly reduces the time or computation required to recover the plaintext from an encrypted message. Common causes of vulnerabilities include design flaws (e.g., software and hardware), botched administrative processes, lack of awareness and education in information security, and technological advancements or improvements to current practices.

In accordance with various aspects of the invention, methods, computer-readable media, and apparatuses are disclosed for assessing different technologies for an organization. The different technologies may incorporate different software packages. An organization may assume one of different entity types, including a financial institution, a manufacturing company, an education institution, a governmental agency, and the like.

Traditional approaches often assess different vulnerabilities associated with a technology in a separate manner. However, a technology is typically associated with numerous vulnerabilities (sometimes in the hundreds), and consequently the assessment of one vulnerability does not adequately reflect the overall risk level of the technology.

With embodiments of the invention, an approach assesses relative risk of different technologies in order to provide a macro-view of a product-related risk across an organization's technology portfolio. For example, the technology portfolio may include a plurality of software packages that are used by the organization to process information within the organization and between other organizations. The approach may support the determination of threat risks for different software packages (software groups) based on prior security findings over a known time span. The determined threat risks may be used to determine which software packages are not a concern, which are within tolerance, and which need to be addressed for possible alternatives within the organization.

With embodiments of the invention, measurements allow for analysis of vendor process maturity and adjustment of behavior to create a lower risk rating as opposed to all-out elimination. A rating can be determined that can be applied to the technologies to set limits of acceptable risk. Anything falling above those limits may be addressed appropriately. Technologies with a limited lifespan may be rated artificially higher than those with a significantly long history.

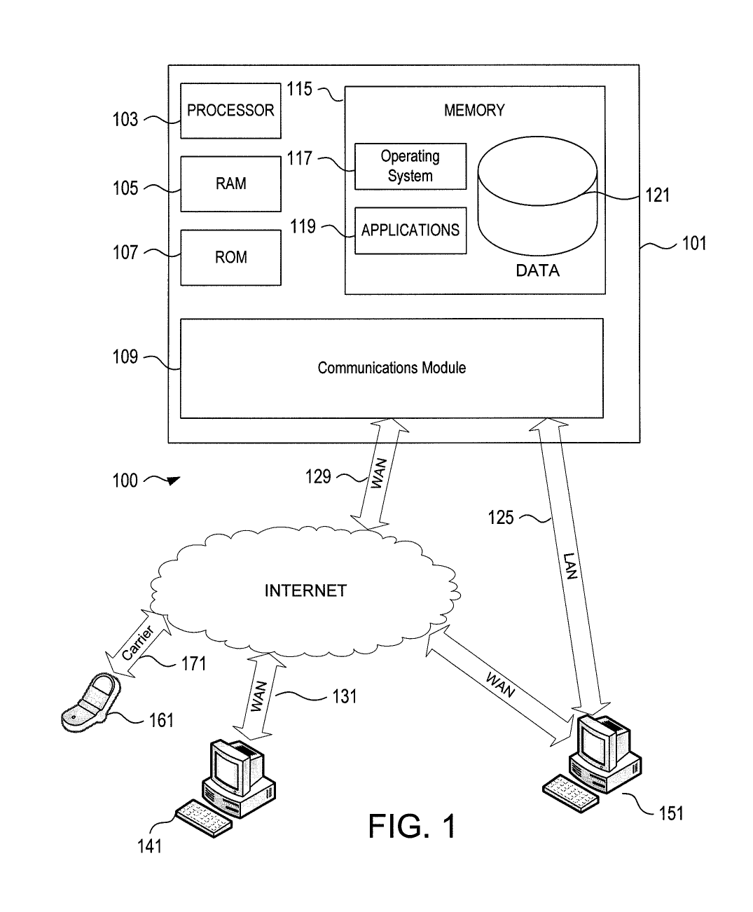

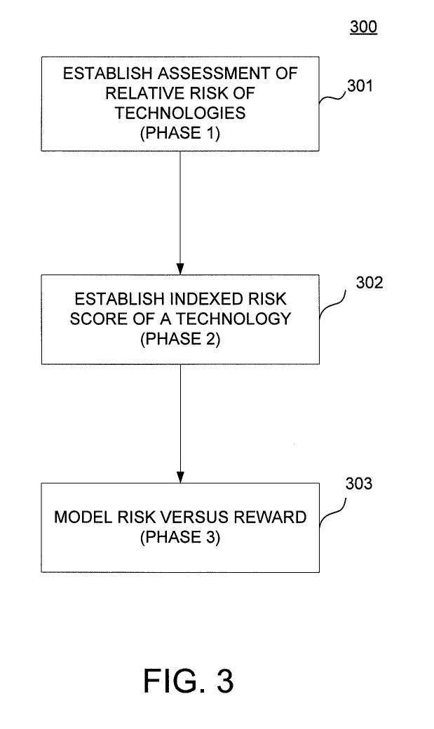

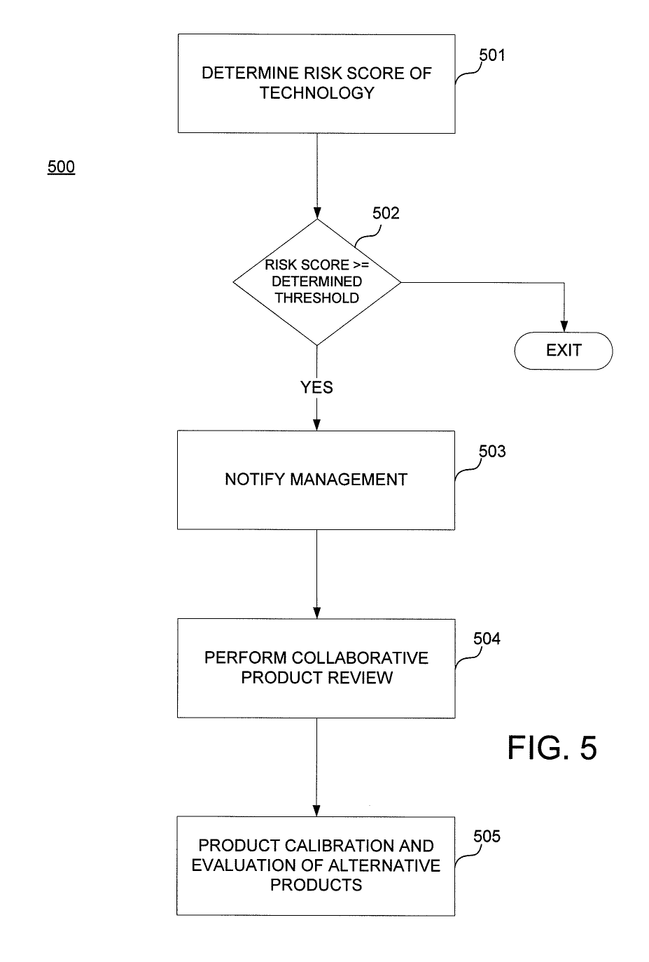

FIG. 1 illustrates an example of a suitable computing system environment 100 (e.g., for processes 300 and 500, as shown in FIGS. 3 and 5, respectively) that may be used according to one or more illustrative embodiments. The computing system environment 100 is only one example of a suitable computing environment and is not intended to suggest any limitation as to the scope of use or functionality of the invention. The computing system environment 100 should not be interpreted as having any dependency or requirement relating to any one or combination of components shown in the illustrative computing system environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

With reference to FIG. 1, the computing system environment 100 may include a computing device 101 wherein the processes discussed herein may be implemented. The computing device 101 may have a processor 103 for controlling overall operation of the computing device 101 and its associated components, including RAM 105, ROM 107, communications module 109, and memory 115. Computing device 101 typically includes a variety of computer readable media. Computer readable media may be any available media that may be accessed by computing device 101 and include both volatile and nonvolatile media, removable and non-removable media. By way of example, and not limitation, computer readable media may comprise a combination of computer storage media and communication media.

Computer storage media include volatile and nonvolatile, removable and non-removable media implemented in any method or technology for storage of information such as computer readable instructions, data structures, program modules or other data. Computer storage media include, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by computing device 101.

Communication media typically embodies computer readable instructions, data structures, program modules or other data in a modulated data signal such as a carrier wave or other transport mechanism and includes any information delivery media. Modulated data signal is a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Computing system environment 100 may also include optical scanners (not shown). Exemplary usages include scanning and converting paper documents, e.g., correspondence, receipts, etc. to digital files.

Although not shown, RAM 105 may include one or more are applications representing the application data stored in RAM memory 105 while the computing device is on and corresponding software applications (e.g., software tasks), are running on the computing device 101.

Communications module 109 may include a microphone, keypad, touch screen, and/or stylus through which a user of computing device 101 may provide input, and may also include one or more of a speaker for providing audio output and a video display device for providing textual, audiovisual and/or graphical output.

Software may be stored within memory 115 and/or storage to provide instructions to processor 103 for enabling computing device 101 to perform various functions. For example, memory 115 may store software used by the computing device 101, such as an operating system 117, application programs 119, and an associated database 121. Alternatively, some or all of the computer executable instructions for computing device 101 may be embodied in hardware or firmware (not shown). Database 121 may provide centralized storage of risk information including attributes about identified risks, characteristics about different risk frameworks, and controls for reducing risk levels that may be received from different points in system 100, e.g., computers 141 and 151 or from communication devices, e.g., communication device 161.

Computing device 101 may operate in a networked environment supporting connections to one or more remote computing devices, such as branch terminals 141 and 151. The branch computing devices 141 and 151 may be personal computing devices or servers that include many or all of the elements described above relative to the computing device 101. Branch computing device 161 may be a mobile device communicating over wireless carrier channel 171.

The network connections depicted in FIG. 1 include a local area network (LAN) 125 and a wide area network (WAN) 129, but may also include other networks. When used in a LAN networking environment, computing device 101 is connected to the LAN 825 through a network interface or adapter in the communications module 109. When used in a WAN networking environment, the server 101 may include a modem in the communications module 109 or other means for establishing communications over the WAN 129, such as the Internet 131. It will be appreciated that the network connections shown are illustrative and other means of establishing a communications link between the computing devices may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages. The network connections may also provide connectivity to a CCTV or image/iris capturing device.

Additionally, one or more application programs 119 used by the computing device 101, according to an illustrative embodiment, may include computer executable instructions for invoking user functionality related to communication including, for example, email, short message service (SMS), and voice input and speech recognition applications.

Embodiments of the invention may include forms of computer-readable media. Computer-readable media include any available media that can be accessed by a computing device 101. Computer-readable media may comprise storage media and communication media. Storage media include volatile and nonvolatile, removable and non-removable media implemented in any method or technology for storage of information such as computer-readable instructions, object code, data structures, program modules, or other data. Communication media include any information delivery media and typically embody data in a modulated data signal such as a carrier wave or other transport mechanism.

Although not required, various aspects described herein may be embodied as a method, a data processing system, or as a computer-readable medium storing computer-executable instructions. For example, a computer-readable medium storing instructions to cause a processor to perform steps of a method in accordance with aspects of the invention is contemplated. For example, aspects of the method steps disclosed herein may be executed on a processor on a computing device 101. Such a processor may execute computer-executable instructions stored on a computer-readable medium.

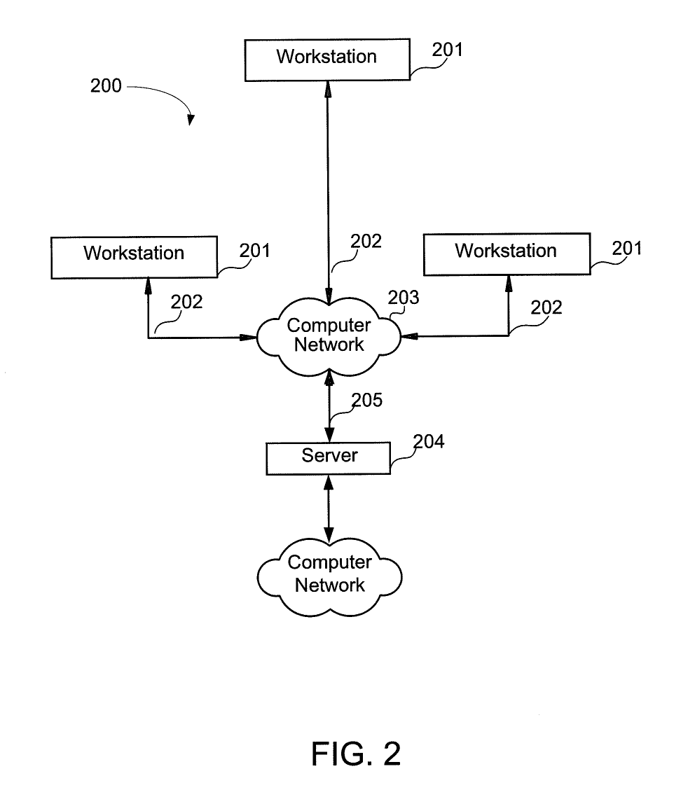

Referring to FIG. 2, an illustrative system 200 for implementing methods according to the present invention is shown. As illustrated, system 200 may include one or more workstations 201. Workstations 201 may be local or remote, and are connected by one of communications links 202 to computer network 203 that is linked via communications links 205 to server 204. In system 200, server 204 may be any suitable server, processor, computer, or data processing device, or combination of the same. Server 204 may be used to process the instructions received from, and the transactions entered into by, one or more participants.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204, such as network links, dial-up links, wireless links, hard-wired links, etc. Connectivity may also be supported to a CCTV or image/iris capturing device.

The steps that follow in the Figures may be implemented by one or more of the components in FIGS. 1 and 2 and/or other components, including other computing devices.

FIG. 3 shows process 300 of assessing technologies in accordance with an aspect of the invention. Process 300 includes three phases of technology risk assessment, although embodiments may incorporate some or all of the phases. For example, some embodiments may include all three phases, while other embodiments may include only phase 1 or may include only phases 2 and 3.

At block 301, the relative risks of different technologies are assessed (designated as phase 1). As will be further discussed, characteristic values for different vulnerabilities associated with the different technologies are obtained, and relative risk scores for each technology is determined at the current time. Characteristic values for the different vulnerabilities may include severity levels measuring possible (potential) risk levels to an organization and an advisory level that measures the risk level of the vulnerability specifically based on the environment of the organization. Severity levels for the vulnerabilities of different technologies may be obtained from a third party while the advisory levels are often determined by the organization itself because the advisory levels are dependent on the characteristics of the organization's environment. For example, when technologies correspond to commercial software packages, an outside consulting service (e.g., iDefense Labs, which is headquartered in Sterling, Va.) may provide an analysis of the different vulnerabilities for the technologies.

While environmental risk scores (based on the organization's environment) scores may be considered, some embodiments may also consider other types of scores for a vulnerability, including base and temporal based on the Common Vulnerability Scoring System (CVSS) methodology.

Even though a vulnerability for a technology may have a large severity level, the technology may be installed only on a few isolated computers in an organization. Consequently, the advisory level for the vulnerability may be substantially less than the corresponding severity level.

At block 302, an indexed risk score for each technology is determined based on time trending variables (designated as phase 2). With some embodiments, inputs may be a number of vulnerabilities (which may be referred as issues), blended advisory/severity scores, and a standard deviation of the blended advisory/severity scores for a given technology as will be further discussed. Phase 2 subsequently provides behavior forecasting of the technologies over a subsequent time duration.

After completing phase 2, further evaluation of technologies at phase 3 may be performed at block 303 in order to determine a risk versus reward model for the different technologies. For example, as will be further discussed, the reward of a technology may be based on the cost and complexity of patching as well as the degree of vendor support for the technology, while the risk may be based on a risk score of the technology.

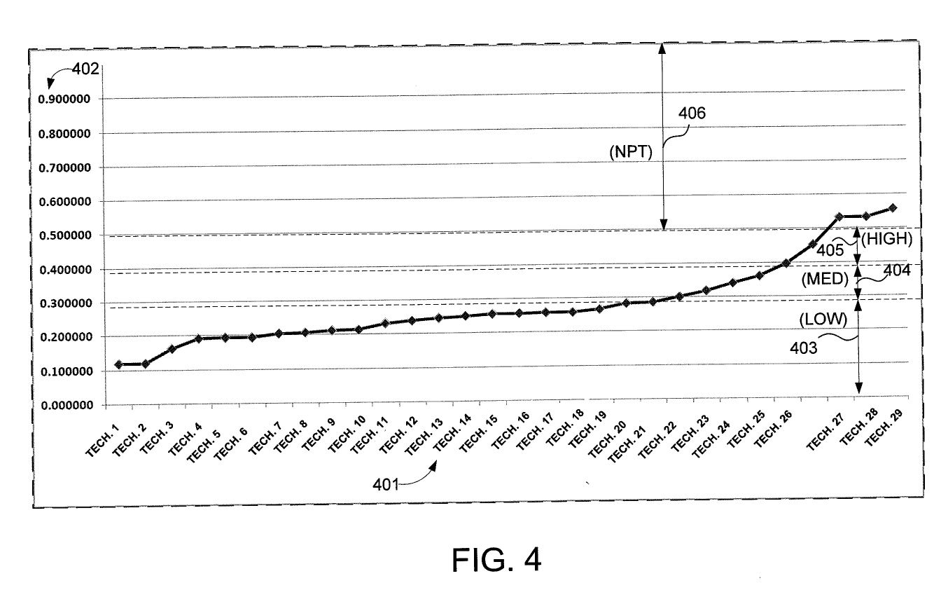

FIG. 4 shows an example of technology risk assessment by risk score in accordance with an aspect of the invention. Technology risk scores 402 is shown relative to different technologies 401 to provide a relative risk assessment of the different technologies at the current time. Technology risk scores 402 typically evaluate the risk level of different technologies in a static fashion at the current time without consideration of the trending of the risks over time.

FIG. 4 displays a graphical representation of the aggregated risk for technologies that are associated with different independent vulnerabilities. The aggregated risk may be determined from factors such as the history of exposure, the complexity and exploit range, CIA (Confidentiality, Integrity and Availability) impact, and the inherent characteristics shift over time. In general, the smaller technology risk score 402 (i.e., closer to zero), the smaller the technology risk for the technology.

With some embodiments, the technology risk score is determined by:

Technology_Risk(X)=((Risk_Level(X))/N)*((ΔVulns(X))/ΔTime) EQ. 1

where Risk_Level(X) is the average severity level of all vulnerabilities for technology X over a given timeframe, N is the average severity level of all vulnerabilities for all technologies over the given timeframe, ΔVulns(X) is the average advisory score for technology X, and T is the value of the timeframe. As previously discussed, with some embodiments the severity level is based on a possible (potential) risk levels to an organization and the advisory score that measures the risk level of the vulnerability based on the environment of the organization. A consulting service (e.g., iDefense) may be assigned a high, medium, or low risk level to the severity level of the vulnerability. The risk level may then be transformed to a numerical value by a predetermined mapping. While the absolute value of the technology risk score depends on the value of the given timeframe, the relative value with respect to other technologies is not affected as long as the timeframe is the same for all technologies.

Referring to FIG. 4, technology 1 has the lowest technology risk score while technology 29 has the highest technology risk score. For example, if the Risk_Level is 2.8 and ΔVulns is 3.5 for technology X, N is 1.76, and ΔTime is 24 months, the technology risk score for technology X is 0.23 (i.e., 2.8/1.76*3.5/24).

The statistical distribution of the technology risk scores 402 for technologies 401 may then be used to determine the relative risk levels for the different technologies. For example, low risk category 403, medium risk category 404, high risk category 405, and non-permitted technologies (NPT) category 406 correspond to scores less than M−σ, between M−σ and M+σ, between M+σ and M+2σ, and greater than M+2σ, respectively, where M is the mean technology risk score for technologies 401. With some embodiments, technologies in categories 403-405 may be used without approval within the organization while technologies in NPT category 406 may be used only with permission. However, technologies in medium risk category 404 and high risk category 405 may be conditionally used based on product evaluation as will be further discussed with FIG. 5.

Referring to FIG. 4, the mean of all the scores is 0.27 and the standard deviation (a) is 0.11. Consequently, low range 403 is categorized till 0.27, medium range 404 till 0.38(0.27+0.11), and high range 405 till 0.49{0.27+(0.11*2)}.

FIG. 5 shows process 500 for evaluating a technology when the associated risk score exceeds a predetermined limit in accordance with an aspect of the invention. A risk rating may be determined that may be applied to set limits of acceptable risk. Anything falling above the determined limit may be further evaluated.

Based on a statistical analysis of technology risk scores 402 for technologies 401 as shown in FIG. 4, an acceptable technology risk scores appear to be less than 0.32. Consequently, for the example in FIG. 4, a technology with a technology risk score greater than 0.32 (which may be designated as the determined threshold in process 500) may be further evaluated.

Referring to process 500 in FIG. 5, at block 501 the technology risk score is determined (e.g., using EQ. 1) for a technology. For example, the results of process 500 may be used to determine which software packages are associated with technologies that are not a concern, within tolerance, or need to be addressed for possible alternatives within the organization.

If the technology risk score is greater than a determined threshold (e.g., 0.32 as previously discussed) at block 502, then further evaluation of the technology is performed at blocks 503, 504, and 505. At block 503 the management of the organization is alerted about the potential risk of the technology. At block 504 the technology (which often includes a product such as a software package) is collaboratively reviewed by the vendor, liaison manager with the vendor, subject matter experts, and product managers. At block 505 possible solutions to reducing the risk level and the evaluation of alternative products are discussed. If it is determined that the risk level of the technology cannot be resolved, an alternative technology (product) may be used by the organization. Measurements may allow for analysis of vendor process maturity and adjustment of behavior to create a lower risk rating as opposed to all-out elimination for use by the organization.

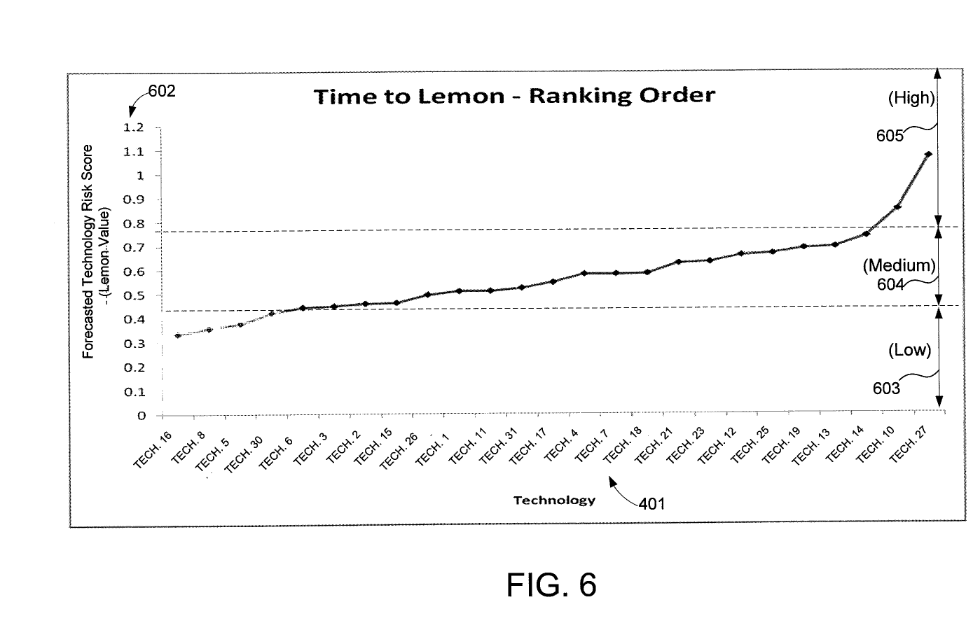

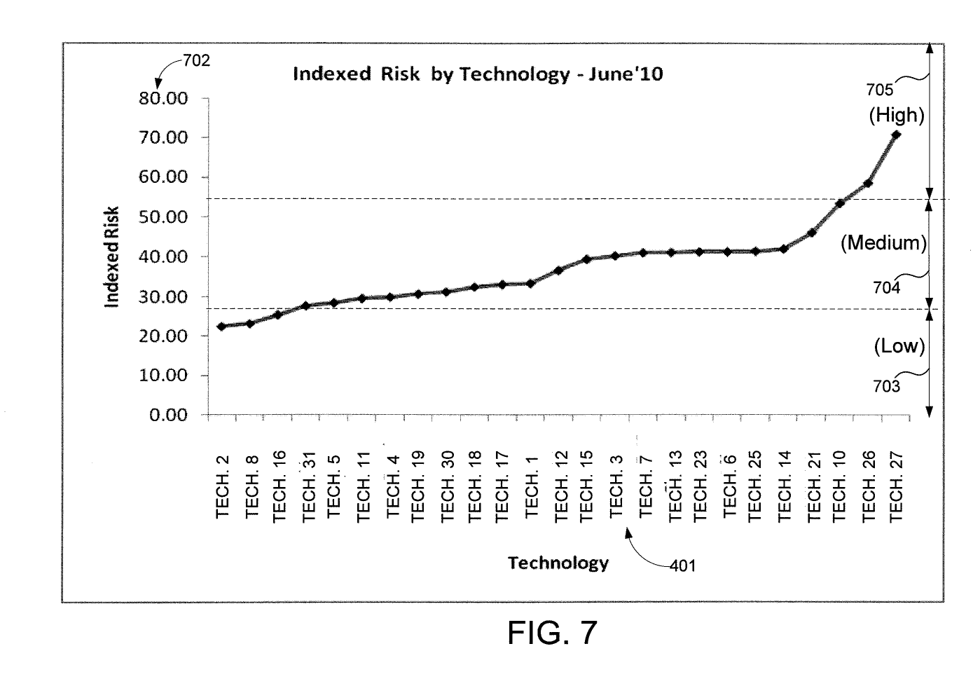

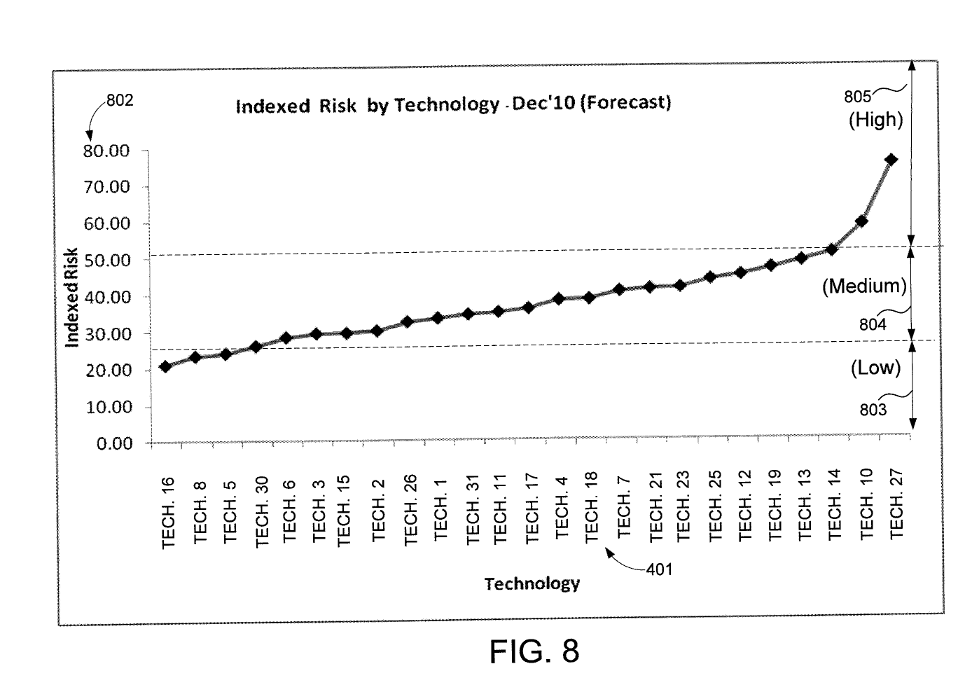

FIG. 6 shows an example of technology risk assessment by forecasted technology risk score (lemon value) 602 for technologies 401 in accordance with an aspect of the invention. As will be discussed, forecasted risk score 602 may be the projected value of a weighted and normalized form of the indexed risk score (EQ. 3). With some embodiments, the forecasted technology risk score is modeled to depend on time trending variables to provide dynamic characteristics of a technology in addition to the static characteristics provided by the technology risk score as previously discussed. FIGS. 7 and 8 illustrate the dynamic risk characteristics of technologies 401, which are rank ordered based on the values of indexed risk scores 702 (based on EQ. 3 and corresponding to June 2010) and forecasted indexed risk scores 802 (based on EQ. 3 and corresponding to December 2010).

In order to obtain forecasted technology risk score 602, the indexed risk score of a technology is first modeled to be depended on three time trending variables:
Number of issues (vulnerabilities) per month. With a higher number of issues, the technology is typically more risky and unstable.
Average blended advisory/severity score in any given month. Generally the higher the value, the higher the overall risk of the technology.
Standard deviation of the average blended advisory/severity score. The more volatile the trend over time, the more risky the technology is.

The average blended advisory/severity score may be determined by adding the weighted sum of the severity level and the advisory level of the corresponding vulnerabilities. For example, with some embodiments, 65% weight was given to the advisory level and 35% to severity level. More weight may be given to the advisory level because the advisory reflects the organization's environment for the technology.

An indexed risk score for a technology may then be obtained by multiplying the above three trending variables as given by:

index_risk_score=number_issues*blended_score*σ_{blended}_{_{—}}_{score} EQ. 2

where number_issues is the number of issues (vulnerabilities) per month, blended_score is the average blended advisory/severity score, and σ_{blended}_{_{—}}_{score} is the standard deviation of the average blended advisory/severity score. For example, if there are 14 issues in a given month, an average blended risk score of 3.60, and a standard deviation of 0.99 for a technology, then the indexed risk score equals 49.9. Weights may be assigned to each of the variables and the weighted score may then be normalized to obtain an adjusted indexed risk score (which may be referred as the final indexed risk score). In the above example, with equal weightage (i.e., 0.33) given to each variable and the scores normalized on a scale of 100, the adjusted indexed risk score is 31.96. The adjusted indexed score may be determined by:

(number_issues+10*σ_{blended}_{_{—}}_{score}20*blended_score)/3 EQ. 3

where number_issues is the number of issues (vulnerabilities) per month, blended_score is the average blended advisory/severity score, and σ_{blended}_{_{—}}_{score} is the standard deviation of the average blended advisory/severity score as with EQ. 2.

The adjusted indexed risk score for each technology may then be projected over a subsequent time duration (e.g., the next 6 months) to forecast the technology behavior (which may be referred as time to lemon). The forecast may be based on an assumed worst case behavior. The forecasted behavior (lemon value) is referred as the forecasted technology risk score 602 as shown in FIG. 6. The results are shown in rank order in FIG. 6 to identify the technologies that are projected to be most risky to the organization. For example, technology 27 has the most risk while technology 16 has the least risk to the organization.

Referring to FIGS. 6, 7, and 8, the risk scores may be categorized into a low risk group (corresponding to low categories 603, 703, and 803, respectively), a medium risk group (corresponding to medium categories 604, 704, and 804, respectively), and a high risk group (corresponding to high categories 605, 705, and 805, respectively). The boundaries of the different categories may be based on the statistical distribution for technologies 401. For example, the a medium category may have a range of ±about the mean value of the risk score, while the low category has a range below this range and the high category has a range above this range.

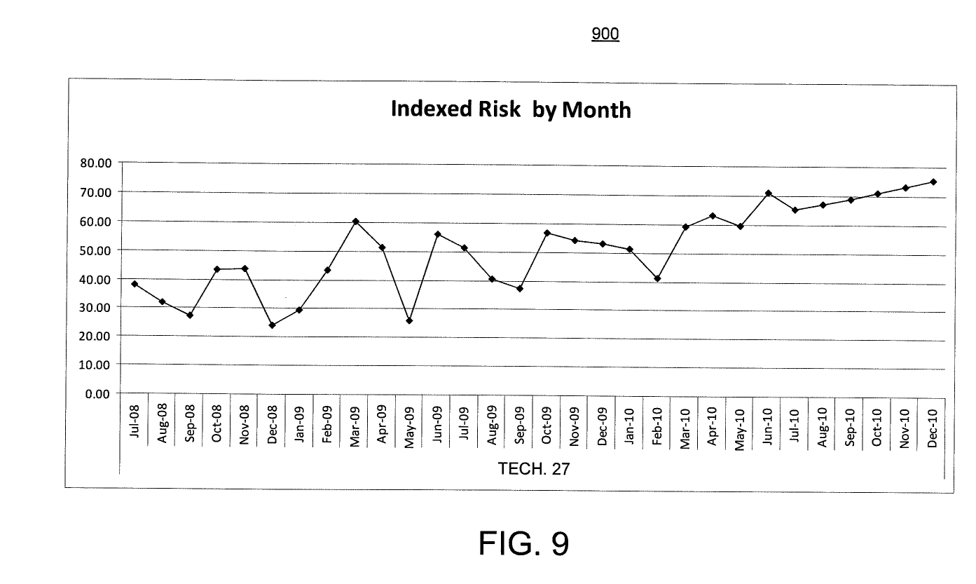

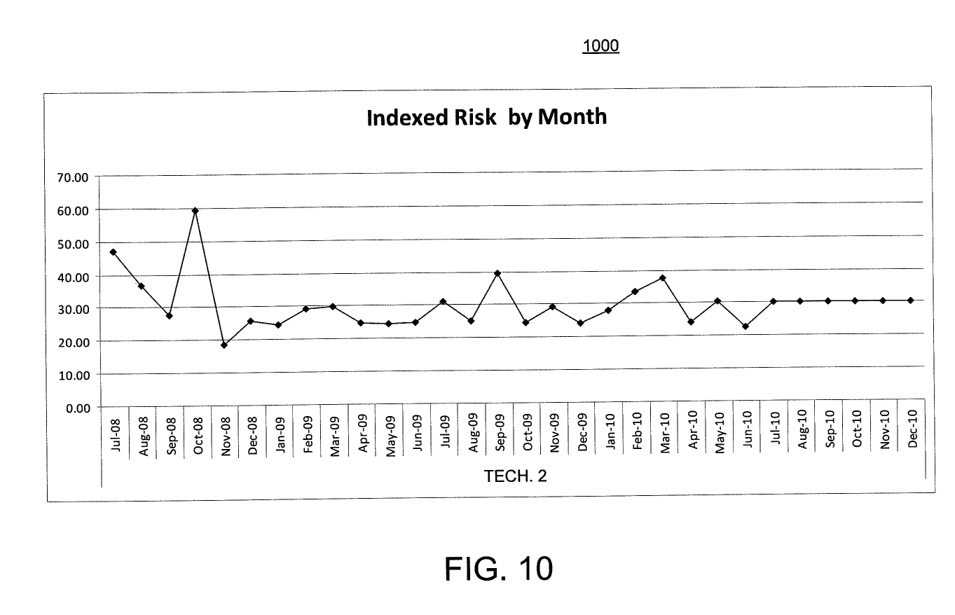

With some embodiments, different smoothing methods may be used for forecasting behavior of the different technologies based on the historical trends for the different technologies. Different trending procedures include log linear trending, damped trend exponential smoothing, mean trending, linear trending, and linear exponential smoothing. Different technologies typical exhibit different degrees of volatility (variation) over time, and consequently trending for different technologies may utilize different trending procedures. For example, FIGS. 9 and 10 show the indexed risk score over time for technologies 27 and 2, respectively. Visual inspection suggests that the indexed risk score for technology 2 is more volatile than for technology 27. Consequently, log linear trending was selected for technology 27 and mean trending was selected for technology 2.

The graphs shown in FIGS. 9 and 10 are representations of risk scores for corresponding technologies. The scores from July-08 to June-10 are based on historical data (i.e., actual risk scores) and the next six data points represented in the graph (July-10 to December 10) are the forecasted scores based on the past trend.

Risk-reward assessment links risk and profitability objectives to improve strategic capital decisions and profitability objectives. Efficient risk-reward assessment assists in providing better business decisions by enabling an organization to reduce costs by enhancing existing risk functions and enabling comprehensive standardization of processes, systems, and data. Embedding an effective risk and reward framework into the key transactions may help the organization to successfully satisfy long-term business objectives in a cost-effective way by taking the right risk to obtain the right reward.

With some embodiments, a data collection identifies the type of risks, the nature and measure of the impact, and the probability and the control effectiveness within the environment. The results of the collection may be used to determine which of the risks is not a concern, within tolerance, need to be addressed for possible alternatives within the organization, and outweigh the expected reward.

With some embodiments, a risk-reward assessment for a technology is modeled based on four variables. The first variable is used to measure the risk, while the other three variables are used to assess the reward.
Derivative of change in time/change in rating—As previously discussed, an indexed risk score of the technology, which is based on the number of issues over time, the blended scores and the standard deviation of the average blended advisory/severity scores, may be used as a measure of the risk.
Cost of Patching—The cost of patching is based distribution of the technology at the organization's environment.
Complexity—The complexity to patch is based on the technology platform (server versus workstation, machines with critical production applications, mass deployment of the patch, and the like).
Vendor Support—The vendor support is based on vendor supportability and frequency of releasing timely official fix's or “End of Life” product.

With some embodiments, the risk-reward assessment may be based on the Sharpe ratio, which is a measure of the excess return (or risk premium) per unit of risk for an investment asset. The Sharpe ratio is defined as:

S(X)=(rₓ−R_{f})/σ(rₓ) EQ. 4

where S(X) is the technology investment for technology X, rₓ is the average asset return for technology X, R_{f} is the return of the benchmark asset, and σ(rₓ) is the standard deviation of rₓ.

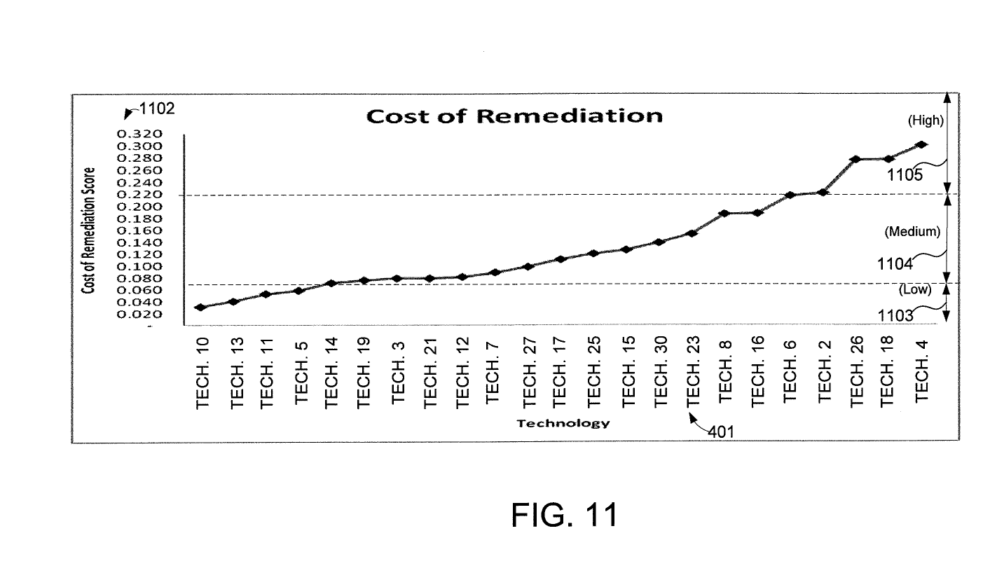

FIG. 11 shows an example of cost remediation 1102 for technologies 401 in accordance with an aspect of the invention. As will be discussed, cost of remediation 1102 may be used in assessing a reward associated with technology.

Cost of remediation 1102 may be referred as the reward component because some embodiments may consider factors not limited only to the cost of remediation or patching but may also include vendor support and complexity.

While embodiments of the invention assess the risk level of technologies 401, some embodiments establish an objective and systematic approach for weighing the potential reward by evaluating relative risk of a given technology across the entire technology portfolio of the organization. For example, one technology may have more risk than another but may also offer a greater reward.

Cost of remediation 1102 may be used to measure the reward when using the Sharpe ratio.

With some embodiments, the cost of remediation may be the same as the cost of maintaining a technology in an organization. Consequently, the more prevalent a technology is, the higher will be the cost of maintenance. In this context, this variable is used as a reward factor to understand and to compare the potential saving that may be ascertained by calling out/eliminating a technology with a high maintenance (keeping the risk factor into consideration). For example, technologies ABC and XYZ are both similar products and both have low risk scores. However, the cost of remediation (or cost of maintenance/reward) for technologies ABC and XYZ are high and medium, respectively. When mapped on a risk/reward scale, the strategic decision is to choose technology XYZ comparing the cost factors.

Cost of remediation 1102 for each technology is generated by giving ⅓ weight to cost of patching, complexity, and vendor support. To assess the final output scores, a Sharpe ratio equivalent may used to understand how well the return of a technology compensates the risk taken (historical data justified on the basis of predicted relationships). With some embodiments, the Sharpe ratio equivalent is determined by dividing cost of remediation 1102 by the indexed risk score (as previously discussed) for the technology and is used to determine the reward score associated with the technology. The Sharpe ratio may be used to fine-tune the reward score, in which the Sharpe ratio ensures that the approach is statistically correct. In general, the higher the Sharpe ratio score, the greater is the reward of the technology in the organization's environment.

The statistical distributions of the risk and reward scores may be analyzed to further assess the risk-reward relationship of technologies 401. For example, categories for the risk level and the reward level may each be partitioned by determining the corresponding mean level and the corresponding standard deviation of each. The low, medium, and high categories include scores less than M−σ, between M−σ and M+σ, and greater than M+σ, respectively, where M is the mean score for technologies 401.

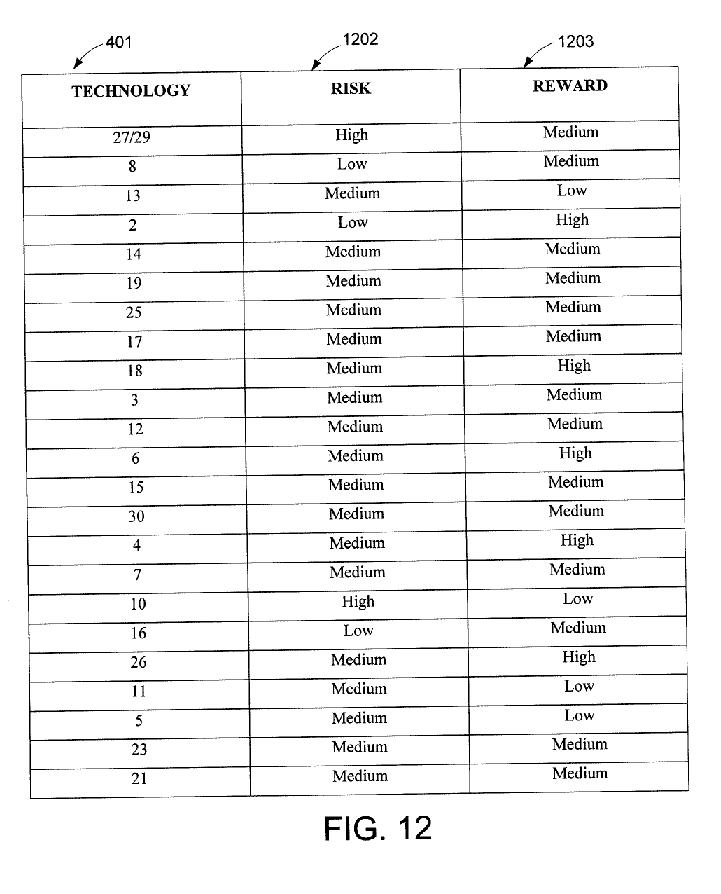

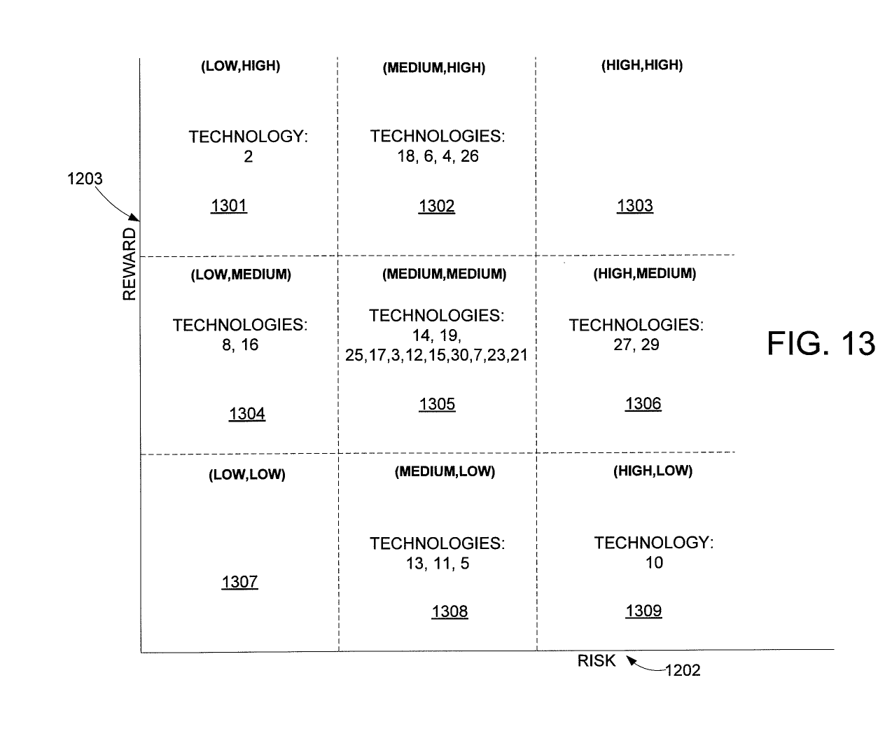

FIG. 12 shows an example of risk scores 1202 and reward 1203 for different technologies 401 in accordance with an aspect of the invention. The risk versus reward output shows the risk adjusted measure of a technology's performance comparing the rewards to the risk generated. FIG. 13 shows a graphical representation of the example shown in FIG. 12, where technologies 401 are partitioned into risk-reward categories 1301-1309. In general, the higher the reward level and the lower the risk level, the more attractive a technology is to an organization. For example, technology 2 is categorized into region 1301 (low risk, high reward) and technology 10 is categorized in region 1309 (high risk, low reward). Consequently, the organization may decide to unconditionally use technology 2 while further evaluating technology 10 to determine whether the risk can be reduced or whether an alternative technology should be used.

Aspects of the embodiments have been described in terms of illustrative embodiments thereof. Numerous other embodiments, modifications and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the embodiments. They may determine that the requirements should be applied to third party service providers (e.g., those that maintain records on behalf of the company).

We claim:

1. A computer-assisted method for evaluating a technology, the method comprising:
obtaining severity levels for a plurality of vulnerabilities associated with a plurality of technologies, the plurality of technologies including a first technology, each severity level measuring a possible risk level of a corresponding vulnerability for an organizational entity;
obtaining environmental risk scores for the plurality of vulnerabilities associated with the first technology, each environmental risk score based on an environment of the organizational entity; and
determining, by a computer system, a technology risk score for the first technology from the severity levels and the environmental risk scores over a time duration.

2. The method of claim 1, wherein the first technology includes a software package.

3. The method of claim 1, further comprising:
repeating the obtaining the environmental risk scores and the determining the technology risk score for the plurality of technologies to obtain a plurality of technology risk scores.

4. The method of claim 3, further comprising:
determining at least one threshold from a statistical distribution of the plurality of technology risk scores; and
categorizing the first technology based on the at least one threshold.

5. The method of claim 1, further comprising:
determining an average combined risk score from the severity levels and the environmental risk scores for the first technology over the time duration; and
determining an indexed risk score for the first technology based on the average combined risk score.

6. The method of claim 5, wherein the indexed risk score is further based on a number of vulnerabilities of the first technology over the time duration.

7. The method of claim 6, further comprising:
repeating the determining the average combined risk score and the determining the indexed risk score for the plurality of technologies to obtain a plurality of indexed risk scores.

8. The method of claim 6, further comprising:
assigning weights to the number of vulnerabilities, the average combined risk score, and a variation of the average combined risk score to obtain a weighted score from the indexed risk score;
normalizing the weighted score to obtain an adjusted indexed risk score for the first technology.

9. The method of claim 8, further comprising:
projecting the adjusted indexed risk score over a projected time duration to obtain a forecasted technology risk score for the first technology.

10. The method of claim 9, further comprising:
repeating the projecting for the plurality of technologies to obtain a plurality of forecasted technology risk scores.

11. The method of claim 10, further comprising:
categorizing the first technology based on a statistical distribution of the plurality of forecasted technology risk scores.

12. The method of claim 9, further comprising:
determining a reward value and a risk value for the first technology, wherein the risk value is based on the forecasted technology risk score.

13. The method of claim 11, further comprising:
repeating the determining the reward value and the risk value for the plurality of technologies to obtain a plurality of reward values and risk values; and
categorizing the plurality of technologies based on the plurality of reward values and risk values.

14. An apparatus comprising:
at least one memory; and
at least one processor coupled to the at least one memory and configured to perform, based on instructions stored in the at least one memory:
determining an average combined risk score from severity levels and environmental risk scores for a first technology over a time duration, wherein:
the first technology is included in a plurality of technologies and incorporates a software package;
each severity level measures a possible risk level of a corresponding vulnerability for an organizational entity; and
each environmental risk score measures an environmental risk level of the corresponding vulnerability based on an environment of the organizational entity; and
determining an indexed risk score for the first technology based on the average combined risk score and a number of vulnerabilities;

15. The apparatus of claim 14 wherein the at least one processor is further configured to perform:
determining an adjusted combined risk score from the indexed risk score by assigning weights to the number of vulnerabilities, the average combined risk score, and a variation of the average combined risk score to obtain a weighted score; and
normalizing the weighted score to obtain an adjusted indexed risk score for the first technology.

16. The apparatus of claim 15 wherein the at least one processor is further configured to perform:
projecting the adjusted indexed risk score over a projected time duration to obtain a forecasted technology risk score for the first technology.

17. The apparatus of claim 16 wherein the at least one processor is further configured to perform:
repeating the projecting for the plurality of technologies to obtain a plurality of forecasted technology risk scores; and
categorizing the first technology based on a statistical distribution of the plurality of forecasted technology risk scores.

18. The method of claim 17, further comprising:
determining a reward value and a risk value for the first technology.

19. The method of claim 18, further comprising:
repeating the determining the reward value and the risk value for the plurality of technologies to obtain a plurality of reward values and risk values; and
categorizing the plurality of technologies based on the plurality of reward values and risk values.

20. A non-transitory computer-readable storage medium storing computer-executable instructions that, when executed, cause a processor to perform a method comprising:
determining an average combined risk score from severity levels and environmental risk scores for a plurality of technologies over a time duration, wherein:
each technology incorporates a different software package;
each severity level measures a possible risk level of a corresponding vulnerability for an organizational entity; and
each environmental risk score measures an environmental risk level of the corresponding vulnerability based on an environment of the organizational entity;
determining an indexed risk score for the plurality of technologies based on the average combined risk score and a number of vulnerabilities;
weighing the number of vulnerabilities, the average combined risk score, and a variation of the average combined risk score to obtain a weighted score and normalizing the weighted score to obtain an adjusted indexed risk score for each technology of the plurality of technologies;
projecting the adjusted indexed risk score over a projected time duration to obtain a forecasted technology risk score for each said technology; and
categorizing each said technology based on a statistical distribution of a plurality of forecasted technology risk scores.

21. The computer-readable medium of claim 20, said method further comprising:
determining a reward value and a risk value for each said technology; and
categorizing the plurality of technologies based on a plurality of reward values and risk values.

22. The method of claim 1, wherein the determining the technology risk score comprises:
dividing a first average security level by a second average severity level times an average advisory score for the first technology divided by the time duration, the first average security level averaged for all vulnerabilities for the first technology, the second average averaged for all vulnerabilities for the plurality of technologies.

23. The method of claim 12, wherein the reward value is determined by subtracting an average return of a benchmark asset from an average asset return for the first technology and dividing by a standard deviation of the average asset return for the first technology.

24. A computer-assisted method for evaluating a technology, the method comprising:
obtaining severity levels for a plurality of vulnerabilities associated with a plurality of technologies, each technology incorporating a different software package, each severity level measuring a possible risk level of a corresponding vulnerability for an organizational entity;
obtaining environmental risk scores for the plurality of vulnerabilities associated with each said technology, each environmental risk score based on an environment of the organizational entity;
determining, by a computer system, a technology risk score for each said technology from the severity levels and the environmental risk scores over a time duration to obtain a plurality of technology risk scores;
determining, by the computer system, at least one threshold from a statistical distribution of the plurality of technology risk scores;
categorizing, by the computer system, each said technology based on the plurality of technology risk scores and the at least one threshold;
determining, by the computer system, an indexed risk score for each said technology based on the severity levels and the environmental risk scores to obtain a plurality of indexed risk scores;
projecting, by the computer system, the plurality of indexed risk scores over a subsequent time duration to obtain a plurality of forecasted technology risk scores;
determining, by the computer system, a reward value and a risk value for each said technology to obtain a plurality of reward values and risk values, wherein the risk value is based on the forecasted technology risk score; and
categorizing, by the computer system, each said technology based on the plurality of reward values and risk values.
